(19) United States
(12) Patent Application Publication
(10) Pub. No.: US 2026/0125625 A1
(43) Pub. Date: May 7, 2026

(54) HOPS ACIDS STABILIZED EMULSIONS

(71) Applicant: Abstrax Tech Inc., Tustin, CA (US)

(72) Inventors: Marcos A. OJEDA, Tustin, CA (US); Marlene A. MCGORRIN, Tustin, CA (US); Iain W.H. OSWALD, Tustin, CA (US); Thomas J. MARTIN, Jr., Tustin, CA (US); Kevin A. KOBY, Tustin, CA (US)

(21) Appl. No.: 19/380,646

(22) Filed: Nov. 5, 2025

Related U.S. Application Data
(60) Provisional application No. 63/717,246, filed on Nov. 6, 2024.

(51) Int. Cl. C12C 3/08

(52) U.S. Cl. CPC C12C 3/08

(57) ABSTRACT

Compositions in the form of an oil-in-water emulsion composition include an oil phase that includes one or more flavorants; and a continuous aqueous phase that includes water, one or more preservatives, one or more emulsifying agents, and optionally one or more emulsifier adjuvants; wherein the preservative includes a hop acid and/or a salt thereof.

### CROSS REFERENCE TO RELATED APPLICATIONS

This application claims the benefit of U.S. Provisional Application No. 63/717,246, filed Nov. 6, 2024, the disclosure of which is incorporated herein by reference in its entirety.

### FIELD

The present invention generally relates to compositions and methods for preserving consumer products. In particular, the present invention relates to various compositions, products, and methods involving oil-in-water emulsions that provide improved preservation of foods and beverages, by using natural preservatives as alternatives to synthetic preservatives.

### BACKGROUND

The following discussion is provided to aid the reader in understanding the disclosure and is not admitted to describe or constitute prior art thereto.

In the food industry, preservatives serve to prevent food from spoiling by extending the shelf life. Generally, this is done by inhibiting the growth of microorganisms such as bacteria, molds, and yeasts, by using preservatives which function as antimicrobial (interfering with the cell), antioxidants, and chemical preservatives, and by affecting the acidity of the environment. In recent years, there has been a focus on replacing synthetic preservatives with natural alternatives. In-vitro studies suggest that these synthetic preservatives (e.g., potassium sorbate) may be toxic to DNA and have a negative effect on immunity.

The shift toward natural products is exemplified by the stringent ingredients accepted by Whole Foods Market (WFM), a major retailer known for its focus on natural and organic products. WFM has banned certain ingredients, including potassium sorbate, from its products, creating a systemic need for alternative natural and safe alternatives. Consumers now demand greater transparency about the ingredients added to their food and beverages. By banning synthetic preservatives, retailers like Whole Foods meets this demand, providing products with clear and straightforward ingredient lists.

Existing natural preservatives often lack the broad-spectrum antimicrobial activity and stability provided by potassium sorbate. Therefore, there is a need for natural alternatives that can effectively replace potassium sorbate in food products.

Among the several natural alternatives being explored, hop acids are one option known for their antimicrobial activity. Hops, traditionally used in brewing, contain alpha acids with antimicrobial properties, making them a promising natural alternative to potassium sorbate. While these compounds' properties are known and recognized within the brewing industry, they are almost exclusively used in their isomerized forms due to enhanced water solubility to impart bitterness. The unisomerized acids naturally found in hops in large concentrations have few commercial applications aside from being a feedstock for their isomerized analogs. Economically, alpha acids are a commodity that is produced in high concentrations by hops and can be easily extracted. Antimicrobial compositions comprising a large amount of one or more hop acid salts are described, for example, in WO2007117433A2. However, hop acids are susceptible to degradation by oxidation, light, and acid catalyzed reactions, which has been seen as limiting their broad use.

At present, there is therefore a need for the development of an additive that not only behaves as an antimicrobial preservative but also functions to stabilize or prevent aggregation of particles within emulsion systems.

### SUMMARY

According to a first aspect, an oil-in-water emulsion composition includes an oil phase that includes about 0.01 wt. % to about 30 wt. %, based on a total weight of the emulsion composition, of a flavorant; and optionally about 0.01 wt. % to about 10 wt. %, based on a total weight of the emulsion composition, of an emulsifier adjuvant; and a continuous aqueous phase of water; containing about 0.01 wt. % to about 30 wt. %, based on a total weight of the emulsion composition, of a preservative including a hop acid and/or a salt thereof; and about 0.01 wt. % to about 10 wt. %, based on a total weight of the emulsion composition, of an emulsifying agent.

In one embodiment, the oil-in-water emulsion composition includes an aqueous phase which includes about 0.001 wt. % to about 8 wt. %, based on a total weight of the emulsion composition, of a preservative comprising a hop acid and/or a salt thereof. In one embodiment, the hop acid includes one or more of an alpha acid, a beta acid, a tetra acid, and an iso-alpha acid. In one embodiment, the preservative may include humulone, cohumulone, adhumulone, lupulone, colupulone, adlupulone, tetrahydroisohumulone, tetrahydroisocohumulone, tetrahydroadlupulone, isohumulone, isocohumulone, or isoadhumulone, or salts thereof. In one embodiment, the hop acid salt may include potassium humulone, potassium cohumulone, potassium cohumulone, potassium humulone, potassium cohumulone, potassium adhumulone, potassium lupulone, potassium colupulone, potassium adlupulone, potassium tetrahydroisohumulone, potassium tetrahydroisocohumulone, potassium tetrahydroadlupulone, potassium isohumulone, potassium isocohumulone, potassium isoadhumulone, or a combination of any two or more thereof. In one embodiment, the oil-in-water emulsion composition includes from about 0.001% to about 0.75% by weight of the total weight of the emulsion composition of the hop acid and/or a salt thereof.

In one embodiment, the flavorant in the oil-in-water emulsion composition may include hop oil, cannabis oil, hemp oil, hop extract, carrier oil, flavorant blends, hop-derived flavorant compounds, non-hop derived flavorant compounds, or a mixture of any two or more thereof. In one embodiment, the flavorant may include a terpene, a terpene blend, a thiol, a ketone, an ester, an aldehyde, an alcohol, a polyfunctional alcohol, a polyfunctional thiol, a heterocycle, or a phenolic. In one embodiment, the flavorant may include a terpene and a non-terpene. In one embodiment, the oil-in-water emulsion composition may include an oil phase that includes about 0.01 wt. % to about 10 wt. %, based on a total weight of the emulsion composition, of a flavorant. In one embodiment, the oil-in-water emulsion composition includes from about 0.05% to about 10% by weight of the total weight of the emulsion composition, of the flavorant.

In one embodiment, the emulsifying agent in the oil-in-water emulsion composition includes a phospholipid, potassium sorbate, sorbitan monooleate, sorbitan monolaurate, sorbitan monopalmitate, sorbitan monostearate, sorbitan monostearate, xanthan gum, guar gum, carrageenan, locust bean gum, monoglycerides, diglycerides, ethoxylated castor oil, albumin, alginates, casein, egg yolk, glycerol monostearate, and a combination of any two or more thereof. In one embodiment, the emulsifying agent includes a sunflower lecithin. In one embodiment, the oil-in-water emulsion composition includes about 0.01% to about 5% by weight of the total weight of the emulsion composition of the emulsifying agent.

In one embodiment, the emulsifier adjuvant in the oil-in-water emulsion composition is selected from the group consisting of citric acid, malic acid, tartaric acid, ascorbic acid, caffeic acid, ferulic acid, and salts thereof. In one embodiment, the oil-in-water emulsion composition includes about 0.01% to about 5% by weight of the total weight of the emulsion composition of the emulsifier adjuvant.

In one embodiment, the water is present in an amount corresponding to the remaining balance of material in the oil-in-water emulsion composition. In one embodiment, the oil-in-water emulsion composition is substantially free of weighting agents.

According to another aspect, a product comprising the oil-in-water emulsion composition is an edible product, a flavor product, or an aroma product. In one embodiment, the edible product comprising a food or beverage product. In one embodiment, the edible product is a food or beverage product. In one embodiment, the beverage is beer, an alcohol containing beverage, or a non-alcohol containing beverage product. In one embodiment, the beverage product is a fermented beverage. In one embodiment, the fermented beverage includes kombucha, beer, wine, or cider.

According to yet another aspect, provided is an oil-in-water emulsion composition comprising: 0 about 0.01 wt. % to about 8 wt. %, based on the total weight of the emulsion composition, of a hop acid and/or a salt thereof; about 0.5 wt. % to about 10 wt. %, based on a total weight of the emulsion composition, of a flavorant; about 0.01 wt. % to about 5 wt. %, based on the total weight of the emulsion composition, of a sunflower lecithin; and water in an amount corresponding to a remaining balance of material in the oil-in-water emulsion composition. In one embodiment, the wherein the hop acid is an alpha acid, and the salt is selected from the group consisting of potassium humulone, potassium cohumulone, potassium cohumulone, potassium humulone, potassium cohumulone, potassium adhumulone, potassium lupulone, potassium colupulone, potassium adlupulone, potassium tetrahydroisohumulone, potassium tetrahydroisocohumulone, potassium tetrahydroadlupulone, potassium isohumulone, potassium isocohumulone, and potassium isoadhumulone or a combination of any two or more thereof.

According to yet another aspect, provided is a method comprising: (i) providing an oil phase comprising a flavorant and optionally an emulsifier adjuvant; (ii) providing an aqueous phase comprising water a preservative comprising a hop acid and/or a salt thereof, an emulsifying agent, and optionally an emulsifier adjuvant; (iii) mixing the oil phase and the aqueous phase so as to obtain a pre-emulsion; and (iv) homogenizing the pre-emulsion to obtain an oil-in-water emulsion. In one embodiment, the homogenizing includes a multi-stage homogenization process.

According to another aspect, provided is a method for stabilizing an oil-in-water emulsion, the method comprising adding to the emulsion a preservative comprising alpha and beta hop acid and/or salts thereof. In one embodiment, the hop acid includes one or more of an alpha acid, a beta acid, a tetra acid, and an iso-alpha acid. In one embodiment, the preservative is selected from the group consisting of preservative is selected from the group consisting of humulone, cohumulone, adhumulone, lupulone, colupulone, adlupulone, tetrahydroisohumulone, tetrahydroisocohumulone, tetrahydroadlupulone, isohumulone, isocohumulone, and isoadhumulone, and salts thereof. In one embodiment, the hop acid salt is selected from the group consisting of potassium humulone, potassium cohumulone, potassium cohumulone, potassium humulone, potassium cohumulone, potassium adhumulone, potassium lupulone, potassium colupulone, potassium adlupulone, potassium tetrahydroisohumulone, potassium tetrahydroisocohumulone, potassium tetrahydroadlupulone, potassium isohumulone, potassium isocohumulone, and potassium isoadhumulone or a combination of any two or more thereof.

According to one aspect, provided is a method which includes plating the oil-in-water emulsion composition onto wet or dry surfaces of an edible layer or film; and processing the edible layer or film to provide consumable product. In another aspect, provided is a method which includes plating the oil-in-water emulsion composition onto wet or dry particles; and processing the dry particles to provide consumable product. In yet another aspect, provided is a method which includes plating the oil-in-water emulsion composition onto wet or dry surfaces of an edible film or layer, or onto wet or dry particles; treating and drying the film, layer or particles, and processing the dry particles or film to provide consumable product. In one embodiment, the treating includes coating with another layer, agglomeration, encapsulation, or a combination of any two or more thereof. In one embodiment, the consumable product is a food or beverage product

### BRIEF DESCRIPTION OF THE DRAWINGS

FIG. 1 is a flowchart showing a representative method of isolating of alpha and beta acids from hops.

FIG. 2 is a flowchart showing a representative method of preparation of a emulsion compositions using alpha acids and/or salts thereof.

FIG. 3 is a graph showing turbidity measurements (NTU) for oil-in-water emulsions containing Flavorant O and various emulsion systems during accelerated storage shelf-lie testing at 45° C., in an embodiment of the present technology.

FIG. 4A and FIG. 4B are graphs showing particle size measurements (d90) and (d50), respectively, versus time for oil-in-water emulsions containing Flavorant A during accelerated storage shelf-lie testing at 45° C., in an embodiment of the present technology.

FIG. 5A and FIG. 5B are graphs showing particle size measurements (d90) and (d50), respectively, versus time for oil-in-water emulsions containing Flavorant B during accelerated storage shelf-lie testing at 45° C., in an embodiment of the present technology.

FIG. 6A and FIG. 6B are graphs showing particle size measurements (d90) and (d50), respectively, versus time for oil-in-water emulsions containing Flavorant C during accelerated storage shelf-lie testing at 45° C., in an embodiment of the present technology.

FIG. 7A and FIG. 7B are graphs showing particle size measurements (d90) and (d50), respectively, versus time for oil-in-water emulsions containing Flavorant D during accelerated storage shelf-lie testing at 45° C., in an embodiment of the present technology.

FIG. 8A and FIG. 8B are graphs showing particle size measurements (d90) and (d50), respectively, versus time for oil-in-water emulsions containing Flavorant E during accelerated storage shelf-lie testing at 45° C., in an embodiment of the present technology.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As utilized herein with respect to numerical ranges, the terms “approximately,” “about,” “substantially,” and similar terms will be understood by persons of ordinary skill in the art and will vary to some extent depending upon the context in which it is used. If there are uses of the terms that are not clear to persons of ordinary skill in the art, given the context in which it is used, the terms will be plus or minus 10% of the disclosed values. When “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified. As a non-limiting example, a reference to “X and/or Y” can refer, in one embodiment, to X only (optionally including elements other than Y); in another embodiment, to Y only (optionally including elements other than X); in yet another embodiment, to both X and Y (optionally including other elements).

Unless indicated otherwise, reference to “percent” is to be understood as “weight percent,” and reference to “ratio” is as a weight/weight ratio.

As used herein, the term “terpene compound” is understood to mean any organic compound that contains some isoprene subunit within its structure and their oxygenated derivatives.

As used herein, the terms “odor” and “aroma” are used interchangeably and represent the sensory attributes of certain substances perceptibly determined by the olfactory system.

As used herein, the term “emulsion”, refers to a class of disperse systems containing two immiscible liquids (e.g., oil and water), with one of the liquids being dispersed as small spherical droplets (the dispersed phase) in the other (the continuous phase). Emulsions can be characterized by the nature of the emulsifier, the structure or of the emulsion or both. Representative emulsions by structure include oil-in-water (o/w) emulsions, water-in-oil (w/o) emulsions, and oil-in-oil (w/o) emulsions.

As used herein, the term “oil-in-water emulsion” or “o/w emulsion” refers to a composition where small droplets of oil are immersed in water or another liquid. Oil is therefore the dispersed phase, while water is the dispersion medium.

As used herein, the term “water-in-oil emulsion” or “w/o emulsion” refers to a composition where small droplets of water are immersed in oil or another liquid. Water is therefore the dispersed phase, while oil is the dispersion medium.

The term “emulsifier adjuvant” as used herein refers to an agent present in either the oil phase or water phase or both that enhances and/or modifies the action and/or effectiveness of an emulsifier.

As used herein, the term “flavoring agent” or “flavorant” is understood to mean a substance that is meant to impart and/or improve the flavor (taste) and/or aroma impression of substances e.g., food or other substances, and can include both natural and synthetic ingredients. For example, a flavorant can include an aroma and/or a flavor agent. The flavorants may include additional additive(s) that provide additional functional benefits.

The term “flavor enhancer” as used herein refers to substances added to supplement, enhance, or modify the original taste and/or aroma of a food, without imparting a characteristic taste or aroma of its own.

The term “full spectrum hop extract” as used herein refers to a hop material that has not been separated beyond the initial extract produced from the extraction process.

As used herein, the term “terpene compound” is understood to mean any organic compound that contains some isoprene subunit within its structure and their oxygenated derivatives.

The term “flavorant emulsion” as used herein refers to an emulsion in which one or more flavorants are incorporated.

As used here, the term “weighting agent” has its ordinary meaning to those skilled in the art. In general, it refers to an additive that is used to increase the density of a composition, and which aids in keeping an ingredient homogenously dispersed or suspended in the emulsion. As an example, a weighting agent can be an additive incorporated into the oil phase of certain types of emulsions to inhibit gravitational separation of the oil droplets from the water phase.

As used herein, the term “substantially free” may refer to a composition that has little or no content of the stated component. For instance, “substantially free of weighting agent” refers to a composition that has little or no weighting agent, e.g., the content of weighting agent is less than about 0.1 wt. %, less than about 0.01 wt. %, less than about 0.001 wt. %, or less than about 0.0001 wt. % based on the weight of the composition. In some embodiments, the composition is completely free of the stated component.

In recent years, synthetic preservatives such have been dismissed by many consumers and while natural antimicrobial agents have been explored, their role has not been fully realized or integrated into comprehensive formulations for food applications. In the case of emulsions, particularly oil-in-water emulsions, the role of a preservative goes beyond preventing the growth of microorganisms, as they are expected to be multifunctional and offer a broad spectrum of activity, sufficient solubility in water, have pH-independent activity, contribute to emulsion stability, and avoid interaction with other ingredients.

Consequently, the inventors, in their quest to replace synthetic preservatives, discovered that it is difficult to find a naturally occurring additive that can have both antimicrobial properties and the ability to stabilize the charge of an emulsion, and even more difficult is to find additives that possess these characteristics without imparting flavor. The present inventors have surprisingly and unexpectedly discovered that hop alpha acids not only provide antimicrobial properties, but also enhance the stability of particles via surface charge mechanisms and/or prevent aggregation of particles. The present technology thus relates to a novel method and composition for preserving food and beverage products using natural antimicrobial agents as alternatives to synthetic preservatives such as potassium sorbate. The technology leverages alpha acids extracted from hops, which are converted into their salts. These salts exhibit dual functionality: they provide antimicrobial properties and stabilize emulsions through charge repulsion mechanisms. This innovative approach addresses the growing demand for natural preservatives that are effective and safe, while also maintaining product stability and safety. This dual/multi functionality of antimicrobial activity and emulsion stabilization through charge repulsion is a novel approach that had remained unknown. By utilizing the selective salts of alpha acids, the inventors have designed a novel, safe and effective solution for preserving and stabilizing consumer products, which ensures minimal flavor impact when used in food and beverages, while effectively stabilizing the emulsion system and preventing aggregation. It is inside the encapsulation itself. The hop acids and salts are not encapsulated or infused. Rather they are added after the encapsulation to prevent aggregation and sedimentation, and to balance the charge on the surface of the particles.

Disclosed are oil-in-water emulsions, compositions, consumer products including such emulsion compositions, and methods of preparation of such emulsion compositions. In one embodiment, the emulsion compositions include an oil phase comprising one or more flavorant additives and optionally one or more emulsifier adjuvants; and an aqueous phase comprising water, one or more preservatives and one or more emulsifying agents. The aqueous phase may optionally include an emulsifier adjuvant.

In one embodiment, the emulsion compositions described herein include one or more preservatives comprising a hop acid and/or a salt thereof. In one embodiment, the hop acid is obtained by extraction of hops, e.g., CO₂ or butane hash oil (BHO extraction of crude/raw hops. Suitable hop acids include, but are not limited to, alpha acids, beta acids, tetra acids, iso-alpha acids, and salts thereof. Illustrative alpha acids include, without limitation, humulone, cohumulone, adhumulone, and the like or salts thereof. Illustrative beta acids include, without limitation lupulone, colupulone, adlupulone, and the like or salts thereof. Illustrative tetra acids include, without limitation, tetrahydroisohumulone, tetrahydroisocohumulone, tetrahydroadlupulone and the like or salts thereof. Illustrative iso-alpha acids include, without limitation, isohumulone, isocohumulone, isoadhumulone and the like, or salts thereof. Illustrative acid salts include alpha acids salts, iso-alpha salts, and tetra alpha salts. Suitable acid salts include, but are not limited to, sodium, calcium, potassium, and magnesium salts of alpha, beta, tetra, and iso-alpha acids, e.g., potassium humulones, potassium cohumulone, potassium cohumulone, potassium humulone, potassium cohumulone, potassium adhumulone, potassium lupulone, potassium colupulone, potassium adlupulone, potassium tetrahydroisohumulone, potassium tetrahydroisocohumulone, potassium tetrahydroadlupulone, potassium isohumulone, potassium isocohumulone, potassium isoadhumulone or a combination thereof.

The concentration of one or more preservatives would depend on preservation would depend on the end application. For example, in case of beverages the amount of preservative may range from about 10-30 ppm, depending on the bittering quality of alpha acids. The one or more preservatives may constitute about 0.0001% to about 30% by weight of the total weight of the emulsion composition. In one embodiment, the one or more preservatives may constitute up to about 20% by weight of the total emulsion composition, including up to about 15%, up to about 10%, up to about 5%, up to about 2%, up to about 1% or up to about 0.1% by weight of the total weight of the emulsion composition. In one embodiment, the one or more preservatives constitute at least about 0.0001% by weight of the total weight of the emulsion composition, including at least about 0.001%, at least about 0.01%, at least about 0.05%, at least about 0.1%, at least about 0.2%, at least about 0.5%, at least about 1% or at least about 2% by weight. In one embodiment, the one or more preservatives constitute about 0.0001% to about 20% of the total weight of the composition, including without limitation, about 0.001% to about 10%, about 0.005% to about 8%, about 0.01% to about 5%, about 0.05% to about 4%, about 0.01% to about 2%, about 0.01% to about 1%, or about 0.01% to about 0.5% of the total weight of the emulsion composition, or any range including and/or in-between any two of these values. In certain embodiments, the preservatives is present in an amount of from about 0.001 wt. % to about 2 wt. %, based on the total weight of the of the emulsion composition. In certain embodiments, the preservatives is present in an amount of less than 1 wt. %, based on the total weight of the of the emulsion composition, including less than about 1%, less than about 0.95%, less than about 0.9%, less than about 0.85%, less than about 0.8%, less than about 0.75%, less than about 0.6%, or less than about 0.5%, by weight of the total weight of the emulsion composition. In one embodiment, the one or more preservatives includes 0.0001 wt. % to about 0.95 wt. % of a hop acid and/or a salt thereof. In one embodiment, the one or more preservatives includes 0.001 wt. % to about 0.9 wt. % of a hop acid and/or a salt thereof. In one embodiment, the one or more preservatives includes 0.001 wt. % to about 0.8 wt. % of a hop acid and/or a salt thereof. In one embodiment, the one or more preservatives includes 0.01 wt. % to about 0.5 wt. % of a hop acid and/or a salt thereof.

The emulsion compositions may include a flavorant. They can be used as such or diluted in a suitable carrier including but not limited to triacetin, triethyl citrate, limonene, or other common carriers. Suitable flavorants may include natural, plant-derived compounds or synthetic compounds, and are derived or prepared based on certain specific desired taste and/or aroma characteristics. For example, certain flavorants are derived from a plant of Humulus lupulus or from Cannabis sativa. Certain flavorants are derived from or created to mimic the flavorants of products such as fruits, spices, herbs, flowers and the like, or combinations thereof. For example, the flavorant can be selected, e.g., based on the desired aroma and/or flavor characteristics (e.g., fruity, citrus-like, flowery, spicy/herbal, tropical, earthy, piney, and the like).

In one embodiment, the flavorant may include an unmodified or modified or product of an extract. In one embodiment, the flavorant may include an unmodified or modified hop extract. In one embodiment, the flavorant may include raw hop extract (i.e., unrefined as in we did not separate it into parts, such as the terpene fraction, acid fraction, etc.), In one embodiment, the flavorant may include crude hop extract.

Other suitable flavorants for making flavorant emulsions may include, but are not limited to, plant essential oils; botanical extracts (e.g., extracts from plants and plant materials), plant proteins, polysaccharides, starches, gums, oils, antioxidants, hydrocolloids, glucans; natural and artificial flavorants (e.g., substances added to impart aroma and/or flavor); natural and artificial flavor enhancers (e.g., substances added to supplement, enhance, or modify the original taste and/or aroma without imparting a characteristic taste or aroma of their own); natural and artificial flavoring agents and adjuvants (e.g., substances added to impart or help impart a taste or aroma in food); natural and artificial sweeteners-both nutritive and non-nutritive; natural and artificial antioxidants and their salts (e.g., butylated hydroxyanisole (BHA) and butylated hydroxytoluene (BHT), ferulic acid, caffeic acid, etc.); natural and artificial vitamins and their salts (e.g., Vitamin C (ascorbic acid), sodium ascorbate, potassium ascorbate, Vitamin E, Vitamin B, Vitamin K, etc.); natural and artificial nutrient supplements (e.g., substances necessary for the body's nutritional and metabolic processes, such as calcium, magnesium, potassium, etc.); antimicrobial agents (e.g., substances used to preserve food by preventing the growth of microorganisms and spoilage, including fungistats, mold inhibitors, and preservatives such as sorbic acid, and benzoate, suitable for use in consumable and topically applied substances); flavorants derived from or mimicking fruits, spices, herbs, flowers, and the like and combinations thereof; blends of plant-based and non-plant-based flavors (e.g., sweeteners, acids, salts, bittering agents, vitamins, minerals, proteins, hydrocolloids, carbohydrates, fats, oils, waxes, gums, and resins); celluloses and hemi-celluloses, other cellulosic materials, lignins, soluble and insoluble fiber, pectins, tannins, and particulate materials from plants; proteins, polysaccharides, sugars, starches, hydrocolloids, gums, oils, antioxidants, glucans, and acids: found in barley and oats; volatile and semi-volatile compounds from plants and plant materials: including terpenes, terpenoids, terpene blends, thiols, ketones, esters, aldehydes, alcohols, polyfunctional thiols, heterocycles and phenolics; compounds found in hops: resins, oils, waxes, tannins, proteins, pectins, cellulosic materials, alpha-acids, beta-acids, iso-alpha acids, isomerized and un-isomerized acids, rho iso-extract, tetra iso-extract, xanthohumol, polyphenols, and combinations thereof; and compounds found in cannabis (e.g., resins, oils, terpenes, waxes, tannins, proteins, pectins, cellulosic materials, cannabidiol (CBD), cannabidiolic acid (CBDA), tetrahydrocannabinol (THC), tetrahydrocannabinolic acid (THCA), cannabigerol (CBG), cannabichromene (CBC), cannabinol (CBN), cannabielsoin (CBE), iso-tetrahydrocannabimol (iso-THC), cannabicyclol (CBL), cannabicitran (CBT), cannabivarin (CBV), tetrahydrocannabivarin (THCV), cannabidivarin (CBDV), cannabichromevarin (CBCV), cannabigerovarin (CBGV), cannabigerol monomethyl ether (CBGM), cannflavin A, B or C, polyphenols, salts thereof, derivatives thereof, cannabis oil, cannabis extract and combinations thereof).

In one embodiment, the flavorant may include hop oil (e.g., hop essential oil, hop oil, full spectrum hop extract), hop extract (e.g., rho iso-extract, tetra iso-extract), flavonoids (e.g., xanthohumol), polyphenols, carrier oils, flavorant blends, other hop derived compounds such as the salt forms of alpha-acids, beta-acids, polyphenols, etc., or non-hop derived flavorant compound, or a combination of any two or more thereof.

In one embodiment, the emulsion compositions may include xanthohumol and/or its pharmaceutically acceptable salt and/or xanthohumol complex with metal. The xanthohumol, salts and complexes thereof may impart high intrinsic antimicrobial properties to the emulsion compositions. The xanthohumol, salts and complexes thereof can be used in addition to or in place of the flavorants, emulsion adjuvants and preservatives disclosed herein.

Carrier oils may include common flavor carriers, which can improve the sweetness, texture, and shelf life of food and beverages. Suitable flavor carriers include, without limitation, limonene—an organic carrier for organic molecules, triacetin—a viscous carrier commonly used for small volatiles, triethyl citrate—a viscous carrier commonly used for small volatiles, MCT, SCT, LCT (medium (6-12), short (<6), and long chain triglycerides (13-21)) oil-triglycerides that are used as carriers for other compounds, alpha-bisabolol—a sesquiterpenoid that has high solubility with organic compounds, element—a sesquiterpene carrier used for organic compounds, phytol—a diterpenoid carrier used for organic compounds, iso-phytol—a diterpenoid carrier used for organic compounds. Carrier oils, including flavor carriers can be a better alternative to petroleum-based additives because they have anti-bacterial properties and improve humectancy, can help with manufacturing safety and convenience, and can help control how and when flavor is released in a food product.

In one embodiment, the flavorant may be cannabis or hemp based, including extracts of cannabis and hemp. In one embodiment, the flavorant may include cannabinoid compounds. In one embodiment, the flavorant may include a terpene compound, a cannabinoid active agent, and an organosulfur compound. In one embodiment, the flavorant includes bittering acids, and wherein the un-isomerized bittering acids are emulsified to increase water solubility. In one embodiment, the flavorant includes un-isomerized bittering acids, and wherein the un-isomerized bittering acids are emulsified to increase water solubility.

In one embodiment, the flavorant may include ‘flavor enhancers’ such as natural and artificial edible acids and their salts (e.g., food-grade acids and their salts); and fruit acids and their salts (e.g., tartaric acid, citric acid, malic acid, magnesium citrate, sodium citrate, potassium citrate, potassium bitartrate, potassium tartrate, sodium tartrate).

In one embodiment, the flavorant(s) may include, but are not limited to terpenes, terpenoids, terpenes, terpenoids, or blends of terpenes. In one embodiment, the flavorant includes terpenes. Illustrative terpenes include, but are not limited to, α-bisabolol, borneol, camphene, camphor, β-caryophyllene, γ-3-carene, caryophyllene oxide, α-cedrene, β-eudesmol, fenchol, geraniol, guaiol, α-humulene, isoborneol, limonene, linalool, menthol, myrcene, nerol, cis-ocimene, trans-ocimene, α-phellandrene, α-pinene, β-pinene, sabinene, α-terpinene, α-terpineol, terpinolene, α-guaiene, elemene, farnesene, germacrene, guaiol, bergotamene, thujene, ylangene, sabinene hydrate, pinanol, selina-3,7(11)-diene, eudesm-7(11)-en-4-ol, valencene, and the like and combinations and blends thereof (e.g., WAF-FLV). In some embodiments, the flavorants include commercially available terpene blends.

In one embodiment, the flavorants may include an organosulfur compound. Suitable organosulfur compounds include, without limitation, prenyl mercaptan, 2-methylthiophene, 3-methylthiophene, diprenyl disulfide, 3-methyl-2-buten-1-yl thiolacetate, 3-methyl-1-[(3-methyl-2-buten-1-yl) sulfanyl]-2-butene, prenylmethylsulfide (1-(methylsulfanyl)-3-methyl-2-butene), prenyl thioacetate, thiogeraniol, or a combination of any two or more thereof.

In at least one embodiment, the flavorant may be emulsified into a water-soluble liquid or water-soluble powder. In one embodiment, the flavorant may include exogenously added hop oil. In one embodiment, the flavorant may be infused into hop materials. Flavor carriers can improve the sweetness, texture, and shelf life of food and beverages. In other embodiments, the flavorant can be used as such and added directly to consumable products without being infused into hop materials. In one embodiment, The flavorant may be incorporated into a carrier system to provide a flavorant matrix. The flavorant matrix may then be exogenously added, emulsified, and added or infused into a hop material and then added to the composition.

In one embodiment, the flavorant for making flavorant emulsions includes non-hop derived flavorant compounds, e.g., sugar and sugar alcohols, such as saccharides, including monosaccharides, disaccharides, polysaccharides, and polyols. In one embodiment, the emulsion composition may include one or more disaccharides. In one embodiment, the emulsion composition may include one or more polyhydroxy disaccharides. Examples of saccharides and polyols may include, without limitation, lactose, maltose, sucrose, trehalose, dulcitol, glycerol, mannitol, and sorbitol. Addition of such sugar and sugar alcohols to the emulsions may provide a further, unexpected stabilization effect. For example, addition of a small amount of trehalose to the aqueous phase along with the phospholipid emulsifier and emulsifier adjuvant, was observed to provide emulsions with reduced turbidity growth and narrower particle size distributions over accelerated storage relative to otherwise identical formulations lacking trehalose. In one embodiment, the emulsion compositions may include trehalose. In one embodiment, the flavorants may include a non-hop derived flavorant compound. In one embodiment, the non-hop derived flavorant compound includes disaccharides. In one embodiment, the non-hop derived flavorant compound includes trehalose.

The one or more flavorants may constitute about 0.0001% to about 100% by weight of the total weight of the emulsion composition. In one embodiment, the emulsion composition may include up to about 30% of the one or more flavorants by weight of the total emulsion composition, including up to about 20%, up to about 10%, up to about 5%, up to about 2%, up to about 1% or up to about 0.1% by weight of the total weight of the emulsion composition. In one embodiment, the emulsion composition may include at least about 0.0001% of flavorants by weight of the total weight of the emulsion composition, including at least about 0.001%, at least about 0.01%, at least about 0.05%, at least about 0.1%, at least about 0.5%, at least about 1% or at least about 2% by weight. In one embodiment, the emulsion composition may include about 0.0001% to about 30% of flavorants of the total weight of the composition, including without limitation, about 0.001% to about 20%, about 0.005% to about 15%, about 0.01% to about 10%, about 0.05% to about 8%, about 0.1% to about 5%, about 0.5% to about 5%, or about 1% to about 5% by weight of the total weight of the emulsion composition, or any range including and/or in-between any two of these values. In certain embodiments, the flavorant may be present in an amount of from about 0.001 wt. % to about 10 wt. %, based on the total weight of the emulsion composition.

In one embodiment, the emulsion composition may include about 0.01% to about 10% of one or more sugars as the flavorant. In one embodiment, the emulsion composition may include about 0.01% to about 10% of a disaccharide (e.g., polyhydroxy disaccharide) as the flavorant. In one embodiment, the emulsion composition may include at least about 0.001% of one or more polyhydroxy disaccharides by weight of the total weight of the emulsion composition, including at least about 0.01%, at least about 0.05%, at least about 0.1%, at least about 0.2%, at least about 0.3% or at least about 0.5% by weight. In one embodiment, the emulsion composition may include about 0.01% to about 10% of one or more polyhydroxy disaccharides of the total weight of the composition, including without limitation, about 0.08% to about 8%, about 0.05% to about 5%, about 0.8% to about 3%, about 0.1% to about 1%, or about 0.3% to about 0.8% by weight of the total weight of the emulsion composition, or any range including and/or in-between any two of these values. In one embodiment, one or more polyhydroxy disaccharide includes trehalose. In one embodiment, the emulsion composition may include about 0.01% to about 10% of trehalose as the flavorant.

The emulsion compositions may include one or more emulsifying agents with or without added emulsifier adjuvants. The emulsifying agents may be included in the water phase. Suitable emulsifying agents include, but are not limited to, phospholipids (e.g., lecithin), proteins, whey proteins, amino acids, potassium sorbate, sorbitan monooleate, sorbitan monolaurate (SPAN® 20), sorbitan monopalmitate, sorbitan monostearate, sorbitan monostearate, xanthan gum, guar gum, carrageenan, locust bean gum, monoglycerides, diglycerides, ethoxylated castor oil, albumin, alginates, casein, egg yolk, glycerol monostearate, and the like and a combination of any two or more thereof. In one embodiment, the emulsifying agents include soy lecithin, sunflower lecithin, rapeseed lecithin, canola lecithin, safflower lecithin, egg lecithin, and the like or combinations thereof. In one embodiment, the emulsifying agent includes a sunflower phospholipid (sunflower lecithin), e.g., from Perimondo, New York, under the brand names of Sunlipon®, including Sunlipon® 90, Sunlipon® 65, Sunlipon® 50, which are phospholipids containing at least about 60% phosphatidylcholine from sunflower lecithin. In one embodiment, the emulsifying agent includes proteins, e.g., chickpea protein, pea protein (Pisum Sativum), pea protein isolates, fava bean proteins, oat proteins, oat protein concentrates, barley proteins, barley protein concentrates, sesame seed proteins, sesame protein concentrates, zein (from corn), pulse proteins, defatted plant proteins, seed storage proteins, almond (Prunus dulcis L.) protein isolates, canola protein isolates, and the like or a combination of any two or more thereof. In one embodiment, the emulsifying agent includes whey protein concentrates (WPC), hydrolyzed whey protein concentrates, whey protein isolates (WPI), egg white proteins, gelatins, or a combination of any two or more thereof. In one embodiment, the emulsifying agents include amino acids, e.g., glycine, proline, hydroxyproline, phospholipids and the like or a combination of any two or more thereof.

When included in the emulsion composition, either in the oil phase or the water phase or both, the emulsifying agents may include about 0.001% to about 20% by weight of the total weight of the emulsion composition, including without limitation, about 0.005% to about 15%, about 0.01% to about 10%, about 0.05% to about 8%, about 0.1% to about 5%, about 0.1% to about 3%, or about 0.1% to about 2% by weight of the total weight of the emulsion composition or any range including and/or in-between any two of these values. In certain embodiments, the emulsifying agent is present in an amount of from about 0.001 wt. % to about 20 wt. %, based on the total weight of the of the emulsion composition.

The emulsion compositions may include one or more emulsifier adjuvants. Suitable emulsifier adjuvants may include, but are not limited to, acids, salts, components of hop materials, and other emulsion formulation components. Illustrative emulsifier adjuvants may include, but are not limited to chitosan, inulin, carrageenan, flaxseed mucilage, water soluble fraction of almond gum, maltodextrins, carbohydrates such as sugars (e.g., sucrose, glucose, fructose, trehalose, maltose, mannose; starches and modified starches (e.g., corn starch, rice starch, quinoa starch, mucunae bean starch (Mucuna Pruriens), oat beta glucans, barley beta glucans, pectin, low methoxyl pectin, pullulan, dextran, citric acid, tartaric acid, caffeic acid, ferulic acid, sodium citrate, potassium citrate, hop acids (e.g., both isomerized and un-isomerized acids), rho iso-extract, tetra iso-extract, xanthohumol, Vitamin C (ascorbic acid), sodium ascorbate, potassium ascorbate, Vitamin E, Vitamin B, Vitamin K, and the like or a combination of any two or more thereof. Some emulsifier adjuvants can be multifunctional, possessing both stability to the emulsion system and acting as a flavor enhancer (e.g., citric acid and salts thereof).

The emulsifier adjuvants can be introduced separately in either the oil phase or the water phase prior to forming the emulsion. In one embodiment, the emulsifier adjuvants are included in the oil phase. Emulsifying agent(s), with or without emulsifier adjuvants, can be mixed to create an aqueous phase. In some cases a specific component of the emulsion can be multifunctional, providing more than one performance attribute within the emulsion (e.g., aid ease of emulsion formation during processing and increase emulsion stability post-processing and modulate finished emulsion physical and/or chemical properties and when added to a food or beverage enhance the physical and/or chemical and/or sensory properties of the food or beverage, etc.) In one embodiment, the emulsifier adjuvants are included in the water phase. In one embodiment, the emulsifier adjuvants are included in both the oil phase and the water phase. In one embodiment, the emulsifier adjuvants are simultaneously in both the oil phase and the water phase prior to forming the emulsion. Some of the non-limiting benefits associated with the use of an emulsifier adjuvant include, elimination of weighting agents, reduced turbidity, enhanced ease of emulsion formation, increased emulsion stability, decreased loss of flavor volatiles, and extended emulsion shelf-life.

In one embodiment, the emulsion composition may include about 0.0001% to about 15% of the one or more emulsifier adjuvants by weight of the total weight of the emulsion composition. In one embodiment, the emulsion compositions include up to about 10% of emulsifier adjuvants by weight of the total emulsion composition, including up to about 8%, up to about 6%, up to about 5%, up to about 2%, up to about 1% or up to about 0.1% by weight of the total weight of the emulsion composition. In one embodiment, the emulsion compositions include at least about 0.0001% of emulsifier adjuvants by weight of the total weight of the emulsion composition, including at least about 0.001%, at least about 0.01%, at least about 0.05%, at least about 0.1%, at least about 0.5%, at least about 1% or at least about 2% by weight. In one embodiment, the emulsion compositions include about 0.0001% to about 15% of emulsifier adjuvants of the total weight of the composition, including without limitation, about 0.001% to about 12%, about 0.005% to about 10%, about 0.01% to about 8%, about 0.05% to about 6%, about 0.1% to about 5%, about 0.1% to about 3%, or about 0.1% to about 2% by weight of the total weight of the emulsion composition, or any range including and/or in-between any two of these values. In certain embodiments, the emulsifier adjuvant is present in an amount of from about 0.001 wt. % to about 10 wt. %, based on the total weight of the of the emulsion composition. In certain embodiments, the emulsifier adjuvant is present in an amount of from about 0.01 wt. % to about 5 wt. %, based on the total weight of the of the emulsion composition.

In one embodiment, the emulsion compositions described herein are substantially free of a weighting agent. Commonly used weighting agents include, but are not limited to brominated vegetable oil (BVO), glycerol ester of wood rosin/glyceryl abietate (ester gum), sucrose acetate isbutyrate (SAIB), sucrose octa-isobutyrate, sucrose octa-acetate, sucrose hepta-isobutyrate, sucrose octa-propionate, propylene glycol dibenzoate, glycerol tribenzoate, methyl ester of hydrogenated rosin, calcium carbonate, manganese tetraoxide, and combinations thereof. In one embodiment, the emulsion compositions contains less than about 0.1 wt. %, less than about 0.01 wt. %, less than about 0.001 wt. %, or less than about 0.0001 wt. %, of the weighting agent (e.g., ester gum, BVO, SAIB, etc.) and/or gum acacia. In one embodiment, the emulsion compositions described herein are free any weighting agent, meaning that the weighting agent (e.g., ester gum, BVO, SAIB, etc.) is completely absent from the emulsion composition or that the emulsion composition includes 0 wt. % of a weighting agent.

The emulsion compositions may further include, either in the oil phase, the aqueous phase or both, additional additives that may provide additional benefits such as enhancements to texture, appearance, stability (chemical, physical, and microbiological stability), shelf-life and other functional benefits. Suitable additional additives include, but are not limited to, antimicrobial agents (e.g., substances used to preserve food by preventing the growth of microorganisms and subsequent spoilage, including fungistats, mold and rope inhibitors, and other effects listed by the national academy of sciences/national research council under “preservatives”); antioxidants (e.g., substances used to preserve food by retarding deterioration, rancidity, or discoloration due to oxidation); colors and coloring adjuncts (e.g., substances used to impart, preserve, or enhance the color or shading of food, including color stabilizers, color fixatives, and color-retention agents); curing and pickling agents (e.g., substances that impart a unique flavor and/or color to food, usually increasing shelf life stability); drying agents (e.g., substances with moisture-absorbing abilities, used to maintain an environment of low moisture); enzymes (e.g., enzymes used to improve food processing and the quality of the finished food); firming agents (e.g., substances added to precipitate residual pectin, strengthening the supporting tissue and preventing collapse during processing); flour treating agents (e.g., substances added to milled flour to improve its color and/or baking qualities, including bleaching and maturing agents); formulation aids (e.g., substances used to promote or produce a desired physical state or texture in food, including carriers, binders, fillers, plasticizers, film-formers, and tableting aids); humectants (e.g., hygroscopic substances incorporated in food to promote moisture retention, including moisture-retention agents and antidusting agents); leavening agents (e.g., substances used to produce or stimulate the production of carbon dioxide in baked goods to impart a light texture, including yeast, yeast foods, and calcium salts listed under “dough conditioners”); nutrient supplements (e.g., substances necessary for the body's nutritional and metabolic processes); oxidizing and reducing agents (e.g., substances that chemically oxidize or reduce another food ingredient, thereby producing a more stable product, including effects listed under “dough conditioners”); pH control agents (e.g., substances added to change or maintain active acidity or basicity, including buffers, acids, alkalis, and neutralizing agents); processing aids (e.g., substances used as manufacturing aids to enhance the appeal or utility of a food or food component, including clarifying agents, clouding agents, catalysts, flocculants, filter aids, and crystallization inhibitors); sequestrants (e.g., substances that combine with polyvalent metal ions to form a soluble metal complex, improving the quality and stability of products); solvents, carriers and vehicles (e.g., substances used to extract or dissolve another substance); stabilizers and thickeners (e.g., substances used to produce viscous solutions or dispersions, to impart body, improve consistency, or stabilize emulsions, including suspending agents, bodying agents, setting agents, jellying agents, and bulking agents); surface-active agents (e.g., substances used to modify surface properties of liquid food components for various effects, including solubilizing agents, dispersants, detergents, wetting agents, rehydration enhancers, whipping agents, foaming agents, and defoaming agents); synergists (e.g., substances that react with another food ingredient to produce an effect different or greater than the sum of the effects produced by the individual ingredients); texturizers (e.g., substances that affect the appearance or feel of the food); acids, including inorganic and organic acids and their salts (e.g., citric acid, tartaric acid, malic acid, folic acid, fumaric acid, lactic acid, acetic acid, phosphoric acid, ascorbic acid); salts including hydroxides, carbonates, bicarbonates, chlorides, gluconates, acetates, sulfides and sulfides of sodium, potassium, calcium, magnesium, and the like (e.g., chlorides, such as sodium chloride, potassium chloride, and magnesium chloride; carbonate salts, such as sodium carbonate, potassium carbonate, and calcium carbonate; bicarbonate salts, such as sodium bicarbonate; phosphate salts, such as disodium hydrogen phosphate, trisodium phosphate, dipotassium hydrogen phosphate, and tripotassium phosphate; sodium polyphosphate; citrate salts, such as sodium citrate; hydroxides such as sodium hydroxide, potassium hydroxide, magnesium hydroxide; acetates such as sodium acetate, potassium acetate; lactates such as sodium lactate, calcium lactate, magnesium lactate); and the like, or combinations thereof. Depending upon the end application, the compositions may include other ingredients, such as surfactants, co-solvents, propellants, other flavoring agents, medicinal agents, perfumes, stabilizers, thickeners, binders, preservatives, emulsifiers, essential oils, water, sweeteners, gelatin, food additives, colorants, carriers, excipients, diluents, and the like or a combination of any two or more thereof.

When included, the emulsion compositions may include about 0.001% to about 20% of the one or more additional additives by weight of the total weight of the emulsion composition, including without limitation, about 0.005% to about 15%, about 0.01% to about 10%, about 0.05% to about 8%, about 0.1% to about 5%, about 0.1% to about 3%, or about 0.1% to about 2% by weight of the total weight of the emulsion composition or any range including and/or in-between any two of these values. In certain embodiments, the additional additives is present in an amount of from about 0.001 wt. % to about 10 wt. %, based on the total weight of the of the emulsion composition.

In one aspect, the present technology provides a composition in the form of an oil-in water emulsion comprising: an oil phase comprising from about 0.01 wt. % to about 30 wt. % of one or more flavorants; and a continuous aqueous phase comprising water, from about 0.001 wt. % to about 10 wt. % of one or more preservatives and about 0.01 wt. % to about 15 wt. % of one or more emulsifying agents, wherein all weight percentages are based on the total weight of the composition. The aqueous phase, the oil phase or both may optionally be about 0.01 wt. % to about 10 wt. % of one or more emulsifier adjuvants. In one embodiment, the preservative includes one or more hop acids. In one embodiment, the preservative includes one or more of alpha acids, beta acids, tetra acids, iso-alpha acids, and salts thereof. In one embodiment, the preservative is selected from the group consisting of humulone, cohumulone, adhumulone, lupulone, colupulone, adlupulone, tetrahydroisohumulone, tetrahydroisocohumulone, isohumulone, tetrahydroadlupulone, isocohumulone, isoadhumulone and the like or salts thereof. In one embodiment, the preservative is an alpha acid or a salt thereof. In one embodiment, the preservative includes (or is) a potassium salt of an alpha acid. In one embodiment, the emulsifying agent includes a sunflower phospholipid. In one embodiment, the emulsifying agent is lecithin (e.g., sunflower lecithin). In one embodiment, the flavorant includes a one or more of terpene, terpene blends, thiols, ketones, esters, aldehydes, alcohols, polyfunctional alcohols, polyfunctional thiols, heterocycles, and phenolics. In one embodiment, the flavorant includes hop oil, cannabis oil, hemp oil, hop extract, flavorant blends, hop-derived flavorant compounds, carrier oils, or non-hop derived flavorant compounds.

The emulsion compositions described herein may be used in a variety of products including edible products, aerosol products, aroma products, flavor products, and consumer products. The compositions may synergistically enhance the olfactory effects of products to which they are added. In certain embodiments, the compositions can be used as an additive to synergistically enhance the aroma and/or flavor of products such as edible products, aerosol products, aroma products, flavor products, and consumer products. In certain embodiments, the edible product is a food product or a beverage product.

The emulsion compositions described herein may be used in a wide variety of products including, but not limited to, baked goods and baking mixes (e.g., ready-to-eat and ready-to-bake products, flours, and mixes requiring preparation); alcoholic beverages (e.g., malt beverages, wines, distilled liquors, and cocktail mixes), nonalcoholic beverages (e.g., special or spiced teas, soft drinks, coffee substitutes, and fruit and vegetable flavored gelatin drinks); breakfast cereals (e.g., ready-to-eat, instant, and regular hot cereals); cheeses (e.g., curd and whey cheeses, cream, natural, grating, processed, spread, dip, and miscellaneous cheeses; confectionaries (e.g., chewing gum; gummies, candy, hard and soft candy, candy bars, chocolates, fudge, mints, and other chewy candies); coffee and tea (e.g., regular, decaffeinated, and instant types); condiments and relishes (e.g., plain seasoning sauces and spreads, olives, pickles, and relishes); confections and frostings (e.g., flavored frostings, marshmallows, baking chocolate, and various sugars); dairy product analogs (e.g., nondairy milk, creamers, coffee whiteners, toppings, and other nondairy products); dairy based drinks, egg products (e.g., liquid, frozen, or dried eggs); fats and oils (e.g., margarine, dressings, butter, salad oils, shortenings, and cooking oils); fish products (e.g., prepared main dishes, salads, appetizers, frozen meals, and spreads containing fish); fresh eggs (e.g., cooked eggs and dishes made from fresh shell eggs); fresh fish (e.g., fresh and frozen fish, shellfish, and other aquatic animals); fresh fruits and fruit juices (e.g., raw fruits, citrus, melons, berries, and home-prepared punches); fresh meat and meat products (e.g., fresh or home-frozen beef, veal, pork, lamb, or mutton, meat-containing dishes, salads, appetizers, frozen meals, and deli meat); fresh poultry and poultry products (e.g., fresh or home-frozen poultry and game birds, poultry and poultry-containing dishes, salads, appetizers, frozen meals, and sandwich ingredients); fresh vegetables (e.g., tomatoes, and potatoes, fresh and home-prepared vegetables); frozen dairy desserts and mixes (e.g., ice cream, ice milks, sherbets, and other frozen dairy desserts); fruit and water ices; gelatins, puddings, and fillings (e.g., flavored gelatin desserts, puddings, custards, parfaits, pie fillings, and gelatin base salads); grain products and pastas (e.g., macaroni and noodle products, rice dishes, and frozen multicourse meals); gravies and sauces (e.g., meat sauces, gravies, and various specialty sauces); hard candy and cough drops; herbs, seeds, spices, seasonings, blends, extracts, and flavorings; jams and jellies (e.g., home-prepared and commercially processed jams, jellies, fruit butters, preserves, and sweet spreads); milk and milk products (e.g., whole, low-fat, skim fluid milks, flavored milks, dry milks, toppings, snack dips, spreads, weight control milk beverages, and other milk origin products); nuts and nut products (e.g., whole or shelled tree nuts, peanuts, coconut, and nut spreads); plant protein products (e.g., meat, poultry, and fish substitutes, analogs, and extender products made from plant proteins); processed fruits and fruit juices (e.g., commercially processed fruits, salads, juices, punches, concentrates, and drink substitutes); processed vegetables and vegetable juices (e.g., commercially processed vegetables, dishes, frozen meals, and vegetable juices); snack foods (e.g., chips, pretzels, and other novelty snacks); soups and soup mixes (e.g., home-prepared and commercially made meat, fish, poultry, vegetable, and combination soups; white granulated sugar; granulated, liquid, and tablet sugar substitutes; sweet sauces, toppings, and syrups (e.g., chocolate, berry, fruit, corn syrup, and maple sweet sauces and toppings). These potential applications, illustrate the versatility and wide-reaching impact of the emulsion compositions provided in the disclosure.

In another aspect, the present technology relates to various products that may include the emulsion compositions described herein. Illustrative products include, without limitation, edible products, aerosol products, aroma products, or flavor products. In certain embodiments, an edible product comprising an emulsion composition described herein is provided. In certain embodiments, the edible product is a food or beverage product. In one embodiment, the present technology relates to beverage products that may include the emulsion compositions described herein. In certain embodiments, the beverage is a fermented beverage including but not limited to kombucha, beer, wine, cider. In certain embodiments, the beverage is beer, any alcohol containing beverage, or other non-alcohol beverage product. In certain embodiments, a flavor and aroma product comprising the emulsion composition described herein is provided. In certain embodiments, a flavor and/or aroma delivery system comprising the emulsion composition described herein is provided.

The emulsion compositions described herein may synergistically enhance the olfactory effects of products to which they are added. In certain embodiments, the compositions can be used as an additive to synergistically enhance the aroma and/or flavor of products such as edible products, aerosol products, aroma products, flavor products, and consumer products. In certain embodiments, the edible product is a food product or a beverage product.

The emulsion compositions may be included in the products in an amount suitable to provide the desired stability or other property of the product, ranging from about 0.0001% to 50% by weight or volume, including from about 0.001% to 30%, about 0.05% to 20%, about 0.01% to 10%, about 0.01% to 5%, or about 0.01% to 3%, of the total weight or volume of the product, or any range including and/or in-between any two of these values For example, when used in a beverage, the emulsion compositions may be included in a concentration range of from about 0.01% to 10%, or about 0.05% to 8%, or about 0.1% to 5%, or about 0.5% to 3%, by volume, depending on the specific beverage formulation.

In one embodiment, the present technology relates to beverage products that may include the emulsion compositions described herein. Traditional compositions and emulsification methods for preparation of oil-in-water emulsions suitable for use in beverage products rely on the use of weighting agents (e.g., ester gum, brominated vegetable oil, etc.) to achieve aroma and/or flavor enhancements in a stable emulsion. The present technology, in one embodiment, the emulsion compositions eliminate the use of weighting agents. In one embodiment, the water is present in an amount corresponding to the remaining balance of material in the oil-in-water emulsion composition. In one embodiment, the oil-in-water emulsion composition is free of a weighting agent. In one embodiment, the oil-in-water emulsion composition is free of gum acacia. In one embodiment, the oil-in-water emulsion composition is free of polysorbates. In one embodiment, the oil-in-water emulsion composition is free of quillaja. In one embodiment, the oil-in-water emulsion composition exhibits improved stability as compared to an identically formulated composition containing a weighting agent and/or gum acacia.

In another aspect, the present technology relates to methods for preparing an oil-in-water emulsion. For example, provided herein are methods for preparing an oil-in-water emulsion said method comprising: (i) providing an oil phase comprising one or more flavorant additives and one or more emulsifier adjuvants; (ii) providing an aqueous phase comprising water and one or more emulsifying agents and optionally one or more emulsifier adjuvants; (iii) mixing said oil phase and said aqueous phase so as to obtain said oil-in-water emulsion.

In another aspect, the method for preparing an oil-in-water emulsion further includes preparation of the alpha acid or alpha acid salt, wherein the method includes, (a) subjecting crude/raw hops to CO₂ or butane hash oil (BHO) extraction methods to obtain a crude extract; (b) distilling the crude extract to remove essential oils; (c) isolating the alpha acids from the distilled extract; and (d) converting the alpha acid into their salts (e.g., potassium salt).

In another aspect, the method for formulating a consumer product is provided, wherein the method includes, (a) extracting alpha acids from hops; (b) converting the extracted alpha acids into their potassium salts; and (c) adding the potassium salts of alpha acids to a formulation to provide antimicrobial properties and stabilize the emulsion within the consumer product. Examples of suitable vitamin salts, may include, without limitation, potassium humulones, potassium cohumulone, potassium cohumulone, potassium humulone, potassium cohumulone, potassium adhumulone, potassium lupulone, potassium colupulone, potassium adlupulone, potassium tetrahydroisohumulone, potassium tetrahydroisocohumulone, potassium tetrahydroadlupulone, potassium isohumulone, potassium isocohumulone, and potassium isoadhumulone or a combination thereof.

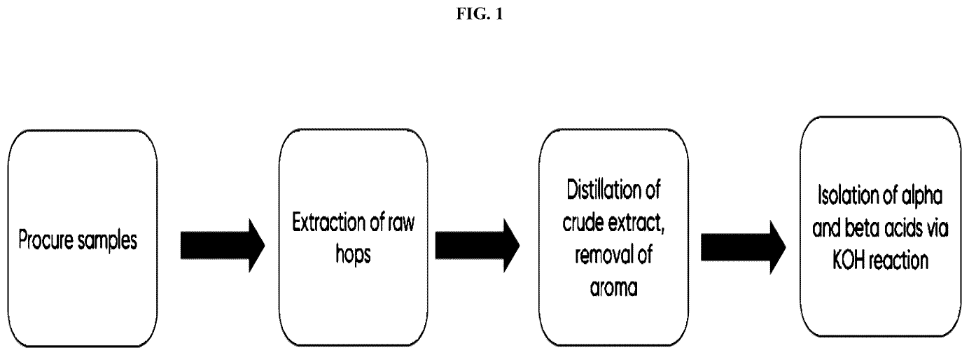

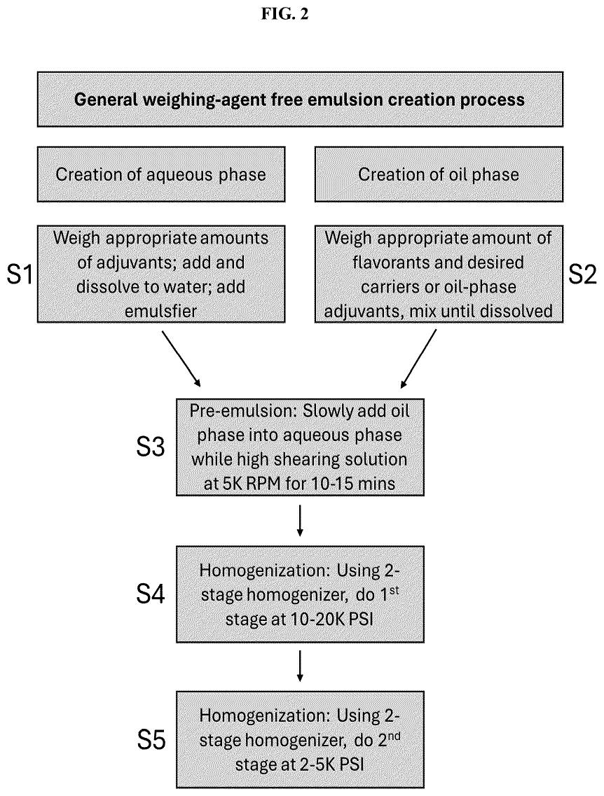

FIG. 1 is a schematic representation of a method of isolating of alpha and beta acids from hops. FIG. 2 shows a schematic representation of a method of preparation of the water phase using alpha acids (e.g., the emulsion is made using salts of alpha acids). In the methods, the emulsion composition may be prepared by adding the oil phase to the aqueous phase or by adding the aqueous phase to the oil phase, or vice versa.

The emulsions of the present technology can be tested for density, pH, turbidity, particle size, stability, and consistency. For oil-in-water emulsions, a crucial stability factor is the electrostatic charge carried by the oil droplets. Particles that are similarly charged will repel each other in solution and emulsion separation is less likely. The oil droplet surface charge is typically characterized by the emulsion's zeta potential, a measure of the sign and magnitude of the surface charge which is defined by the electrophoretic mobility of the droplets. In a typical oil-in-water emulsion, the more negative the zeta potential is, the more stable the emulsion.

The emulsion compositions described herein have several advantages. For example, the emulsion compositions may exhibit improved stability as compared to an identically formulated composition not containing hop acids and salts thereof or containing synthetic preservatives. Improved stability may include short-term stability, long-term stability, or both. For example, improved stability, in one embodiment, may include improved initial stability, e.g., particle size of the initial solution. The present technology is associated with advantages such as elimination of weighting agents, reduced processing times, enhanced regulatory compliance, lower production costs, preservation of flavor and aroma, providing clear beverage emulsions and increasing the emulsion stability and shelf-life. The compositions and methods described herein allow quick, consistent, and easy incorporation of aroma and/or flavor enhancement into diverse types of products. Additionally, the use of synthetic is avoided thereby ensuring compliance with regulatory standards, consumer preference and enhancing the safety profile of the emulsions. The present technology further improves the retention of volatile flavor and aroma compounds during emulsification, resulting in superior sensory quality of the final product. The present technology provides dual-function emulsion stabilizer compositions, which provide both antimicrobial activity and emulsion stabilization through charge repulsion mechanisms. Finally, the present technology enhances the stability and shelf-life of the emulsion compositions without the need for traditional synthetic antioxidants, preservatives, and stabilizers, ensuring consistent performance over time and creates stable oil-in-water emulsions that maintain clarity in products such as beverages, enhancing visual appeal and product quality.

In another aspect, the present technology relates to methods for preparing an oil-in-water emulsion. For example, provided herein are methods for preparing an oil-in-water emulsion said method comprising: (i) providing an oil phase comprising one or more flavorant additives; (ii) providing an aqueous phase comprising water, one or more preservatives and one or more emulsifying agents; (iii) mixing the oil phase and the aqueous phase so as to obtain a pre-emulsion; and (iv) homogenizing the pre-emulsion to obtain an oil-in-water emulsion. In one embodiment, the homogenizing includes a multi-stage homogenization process. The oil phase may be prepared by mixing the one or more flavorant additives. The aqueous phase is prepared by mixing the appropriate amount of preservatives (e.g., hop acids and salts thereof), and distilled water and adding the emulsifying agent in to the water mixture with mixing. In one embodiment, the method includes using a high-shear mixing process to enhance the uniform distribution of the ingredients.

In another aspect, the present technology provides methods for preparing a natural preservative and stabilizer for food and beverages. In yet another aspect, the present technology relates to methods for preserving food and beverages. The methods include forming and stabilizing emulsion compositions for use in food and beverages by using natural preservative agents, wherein the emulsion compositions includes a plant-derived flavorant additive, hop acids and/or salts thereof, and emulsifying agents. In another aspect, the present technology provides methods for enhancing the stability and antimicrobial properties of high-viscosity products, wherein the methods include adding potassium salts of alpha acids extracted from hops to the high-viscosity product; and mixing the product to achieve a stable emulsion and extended shelf life through antimicrobial activity.

In yet another aspect, the present technology provides methods for stabilizing oil-in-water emulsions and preserving products; wherein the method includes adding one or more hop acids and/or salts thereof to the emulsion. The hop acid is selected from the group consisting of alpha acids, beta acids, tetra acids, iso-alpha acids, and salts thereof. In one embodiment, the preservative is selected from the group consisting of humulone, cohumulone, adhumulone, lupulone, colupulone, adlupulone, tetrahydroisohumulone, tetrahydroisocohumulone, tetrahydroadlupulone, isohumulone, isocohumulone, isoadhumulone and the like or salts thereof. In one embodiment, the preservative is an alpha acid or a salt thereof. In one embodiment, the preservative is a potassium salt of an alpha acid. The methods may further include using the stabilized emulsion in food products as a natural alternative to synthetic preservatives. The methods may further include emulsifying one or more flavorant additives, in the presence of hop acids and/or salts thereof, into an oil-in-water emulsion or a multi-layered oil-in-water emulsion suitable for use in consumable substances and topically applied substances.

In one aspect, the present technology relates to methods for using the oil-in-water emulsions or multi-layered oil-in-water emulsions. The methods include, for example, plating the emulsion onto either wet or dry surfaces in the form of layers or films. Such films or edible layers may be used as final products or may undergo further treatment and/or processing as needed to form an edible layer or film that can be consumed or incorporated into a food product. In another embodiment, the methods include, for example, plating the emulsion onto either wet or dry particles Such particles may be used as final products or may undergo further treatment and/or processing as needed to form edible particles that can be consumed or incorporated into a food or beverage product, or that can be dissolved and/or dispersed in a consumable liquid. Further treatment or processing may include step such as e.g., drying, coating with another layer, agglomeration, encapsulation, mixing, blending, size classification, size reduction, milling, spherification, preservation, and the like and combinations of any two or more thereof.

According to another aspect, a method is provided that includes plating the oil-in-water emulsion compositions of the present technology onto wet or dry surfaces of an edible layer or film; and processing the edible layer or film to provide consumable product. In another aspect, provided is a method comprising plating the oil-in-water emulsion compositions of the present technology onto wet or dry particles; and processing the dry particles to provide consumable product. According to yet another aspect, provided is a method comprising plating the oil-in-water emulsion composition of the present technology onto wet or dry surfaces of an edible film or layer, or onto wet or dry particles; treating and drying the film, layer or particles, and processing the dry particles or film to provide consumable product. In one embodiment, the treatment may include coating with another layer, agglomeration, encapsulation, drying, or a combination of any two or more thereof, e.g., layer coating and drying, agglomeration and drying, encapsulation and drying, layer coating, agglomeration and drying, etc. The consumable product may include the food or beverage products, including fermented beverages such as kombucha, beer, wine, or cider.

According to another aspect, a method is provided that includes preparing a consumable product, the method comprising plating the oil-in-water emulsion composition of the present technology onto a wet or dry surface of an edible layer or film; and processing the edible layer or film to provide the consumable product. In another aspect, a method is provided that includes preparing a consumable product, the method comprising plating the oil-in-water emulsion composition of the present technology onto a wet or dry particle; and processing the dry particle to provide the consumable product. In yet another aspect, a method is provided that includes preparing a consumable product, the method comprising plating the oil-in-water emulsion composition of the present technology onto a wet or dry surface of an edible film or layer, or onto a wet or dry particle; treating and drying the film, layer, or particles, and processing the dry particles or film to provide consumable product. In one embodiment, the treating comprises coating with another layer, agglomeration, encapsulation, drying, or a combination of any two or more thereof. In one embodiment, the consumable product is a food or beverage product.

In one aspect, the present technology provides methods preserving products (e.g., food or beverage products); wherein the method includes formulating the product with an emulsion containing oil and water; and stabilizing the emulsion by adding hop acids and/or salts thereof. The product may be a consumer product, such as a food product or a beverage product. The methods may further include utilizing the emulsion as a preservative to extend the shelf life of the product by providing antimicrobial, antioxidant, and pH-stabilizing properties.

In another aspect, the present technology relates to methods for preparing a natural preservative and stabilizer for food and beverages. In yet another aspect, the present technology relates to methods for preserving food and beverages. The methods includes forming and stabilizing emulsion compositions for use in food and beverages by using natural preservative agents which include hop acids and salts thereof, including one or more of alpha acids, beta acids, tetra acids, iso-alpha acids, and salts thereof. In one embodiment, the emulsion composition includes one or more of flavorant additives, one or more of alpha acids, beta acids, tetra acids, iso-alpha acids, and salts thereof, emulsifying agents, and emulsifier adjuvants.

The present invention, thus generally described, will be understood more readily by reference to the following examples, which are provided by way of illustration and are not intended to be limiting of the present invention.

### EXAMPLES

Various embodiments will be further clarified by the following examples, which are in no way intended to limit this disclosure thereto.

### Example 1: Preparation of Emulsion Formulation

Preparation of Oil Phase: Suitable amounts (2-20%) of oil-soluble terpenes are measured and slowly added directly to the water phase while stirring gently to avoid phase separation.

Preparation of Water Phase: Suitable amount of one or more alpha acid salts are measured using a high-precision balance and slowly added to distilled water in a clean beaker. The solution is continuously stirred at a low (5000) RPM during the addition to ensure complete dissolution. Suitable amount of Sunflower lecithin (Sunlipon® 65 commercially obtained from Perimondo, New York, N.Y) is gradually added to the water phase. The solution is mixed for 10-15 min using a Silverson L5M-A mixer with a general mixing head, and its speed set to 5000 RPM. The mixing is done to ensure that the emulsifier fully dissolves, and the temperature is monitored throughout the process to ensure it does not rise above desired levels. The solution is allowed to return to room temperature naturally once mixing is complete. After dissolution is completed, the pH is checked using a pH meter and adjusted if necessary to optimize for stability and preservation.

Preparation of Pre-emulsion Solution: After the aqueous phase is fully mixed its pH measured using a calibrated pH meter. Depending on the product application, the target pH should be set within a range suitable for the emulsion's stability (e.g., between 4.0 and 7.0). If the pH is outside the desired range, it is adjusted incrementally using small amounts of acid or base (e.g., citric acid or sodium hydroxide), checking after each addition till the target pH is reached. The oil phase is slowly added to the prepared water phase while controlling the rate of addition to prevent any sudden phase separation, and while continuing to mix with a general mixer at a lower RPM (around 1000 RPM). After all of the oil phase has been added, the Silverson L5M-A mixer is switched to the emulsifying head and the speed is increased to 5000 RPM. The mixture is mixed for 10 min to ensure thorough emulsification and uniform consistency. A uniform, creamy appearance indicates the oil droplets are evenly dispersed within the water phase. The mixture is inspected to confirm even distribution of the oil droplets in the water phase. The solution is allowed to sit for 30 min to let any excess air bubbles escape, improving the overall stability of the pre-emulsion. De-aeration can also be assisted by a vacuum chamber or desiccator if needed. After de-aeration, the pre-emulsion is inspected for any residual air bubbles or signs of phase separation, and if any are present, the de-aeration is repeated or the solution is re-mixed.

Homogenization: Before starting the homogenization process, the cooling water system and digital pressure gauge are activated to maintain temperature control and monitor homogenization pressures. 200-500 mL of distilled water is added to the feed hopper to adjust the homogenizer parameters before processing the main batch. An APV 1000/2000 homogenizer is prepared by activating the cooling water system and digital pressure gauge. With 500 mL of the pre-emulsion in the feed hopper, the homogenizer is started and the pressure is adjusted to 10000-12000 psi for the first stage. The second-stage pressure is set to 20% of the first stage pressure (approximately 2000-2400 psi). Both the pressure and temperature are carefully monitored during this process to ensure the system operates within safe limits. The pre-emulsion is slowly fed into the homogenizer and processed twice to achieve optimal particle size reduction. The feed hopper is monitored to ensure it does not empty, thereby preventing cavitation. The temperature increases are monitored, ensuring they remain within a 5° C. rise per pass to maintain emulsion integrity. If necessary, external cooling methods are used to keep the temperature within range. The samples are collected during the second homogenization run for performing quality control testing which includes parameters like particle size, stability, and consistency. Once complete, the homogenizer pressure is disengaged by turning the hand wheels counterclockwise, bringing the pressure to zero safely. After homogenization, the emulsion is inspected for visual consistency, texture, and particle size. If possible, a particle size analyzer is used to confirm that the desired size distribution has been achieved. The final temperature, pressure, and time taken for homogenization are recorded to maintain process consistency in future batches, and the emulsion is advanced for further testing or packaging.

### Example 2: Oil-In-Water Emulsion With Alpha Acid Salts

Emulsion compositions was prepared using the method described in Example 1. The emulsion compositions having varying levels of alpha acid salts, in accordance with one embodiment of the present disclosure. The emulsion compositions were prepared using five different flavorant formulations. A listing of flavorant formulations tested, their flavor profiles, and their general chemical composition is provided in Table 1 below:

TABLE 1

| Flavorant | Flavor | |
|---|---|---|
| Formulation | profile | Chemical composition |
| A | Red Cherry | Terpenes, esters, aldehydes, volatile |
| | | sulfur compounds |
| B | Chamomile | Natural extract (terpenoids) |
| C | Grapefruit | Esters, aldehydes, volatile sulfur |
| | | compounds |
| D | Guava | Terpenes, esters, aldehydes, volatile |
| | | sulfur compounds |
| E | Passionfruit | Terpenes, esters, aldehydes, volatile |
| | | sulfur compounds |
| O | Hops (citra) | Terpenes, esters, aldehydes, volatile |
| | | sulfur compounds |

Using the procedure described in Example 1 four emulsion systems were prepared which include potassium alpha acid salts, in combination with the five flavorant formulations A-E from Table 1, to study effect of changing emulsion systems and flavorants on emulsion properties of the resulting emulsion compositions. The emulsion systems were designed to incorporate water-soluble salt forms of different acids derived from hops, including alpha acids (e.g., humulone, cohumulone), iso-alpha acids (e.g., isomerized humulone, isohumulone), and Tetra-Iso-Alpha acids (e.g., tetra-iso-humulone). The emulsion compositions prepared using different flavorants in the in the inventive emulsion systems (EMP-01C, EMP-01E and EMP-01F) are listed in Tables 2-4. All amounts are in wt. %, based in the total weight of the emulsion composition, unless otherwise specified.

TABLE 2

| | | Emulsion System - EMP-01C | | | | | | |
|---|---|---|---|---|---|---|---|---|
| | | | | | Potassium | | | |
| Flavorant | | Ascorbic | Citric | Potassium | Alpha salt | Sunlipon ® | | Water, |
| Formulation | wt. % | acid | Acid | Citrate | (aq. 20%) | 65 | MCT | Distilled |
| A | 2 | 0.05 | 0.04 | 0.07 | 0.01 | 1.00 | 1.00 | 95.83 |
| B | 2 | 0.05 | 0.04 | 0.07 | 0.01 | 1.00 | 1.00 | 95.83 |
| C | 2 | 0.05 | 0.04 | 0.07 | 0.01 | 1.00 | 1.00 | 95.83 |
| D | 2 | 0.05 | 0.04 | 0.07 | 0.01 | 1.00 | 1.00 | 95.83 |
| E | 2 | 0.05 | 0.04 | 0.07 | 0.01 | 1.00 | 1.00 | 95.83 |

TABLE 3

| | | Emulsion System - EMP-01E | | | | | | |
|---|---|---|---|---|---|---|---|---|
| | | | | | | Potassium | | |
| Flavorant | | | Ascorbic | Citric | Sodium | Alpha salt | Sunlipon ® | Water, |
| Formulation | wt. % | Trehalose | acid | acid | citrate | (aq. 20%) | 65 | Distilled |
| A | 2 | 5.00 | 0.02 | 0.04 | 0.07 | 0.01 | 1 | 91.86 |
| B | 2 | 5.00 | 0.02 | 0.04 | 0.07 | 0.01 | 1 | 91.86 |
| C | 2 | 5.00 | 0.02 | 0.04 | 0.07 | 0.01 | 1 | 91.86 |
| D | 2 | 5.00 | 0.02 | 0.04 | 0.07 | 0.01 | 1 | 91.86 |
| E | 2 | 5.00 | 0.02 | 0.04 | 0.07 | 0.01 | 1 | 91.86 |

TABLE 4

| | | Emulsion System - EMP-01F | | | | | | | |
|---|---|---|---|---|---|---|---|---|---|
| | | | | | | Potassium | | | |
| Flavorant | | | Ascorbic | Citric | Potassium | Alpha salt | Sunlipon ® | Sunflower | Water, |
| Formulation | wt. % | Trehalose | acid | Acid | Citrate | (aq. 20%) | 65 | seed oil | Distilled |
| A | 2 | 5.00 | 0.02 | 0.04 | 0.07 | 0.01 | 1.00 | 1.00 | 90.86 |
| B | 2 | 5.00 | 0.02 | 0.04 | 0.07 | 0.01 | 1.00 | 1.00 | 90.86 |
| C | 2 | 5.00 | 0.02 | 0.04 | 0.07 | 0.01 | 1.00 | 1.00 | 90.86 |
| D | 2 | 5.00 | 0.02 | 0.04 | 0.07 | 0.01 | 1.00 | 1.00 | 90.86 |
| E | 2 | 5.00 | 0.02 | 0.04 | 0.07 | 0.01 | 1.00 | 1.00 | 90.86 |

Additional emulsion compositions, containing various alpha acids and/or salts thereof were similarly prepared and tested. The emulsion compositions prepared using emulsion systems (EMP-01J-EMP-01L) containing potassium alpha acid salts, iso-alpha acid salts, and tetra acids salts, in combination with the flavorant formulation O are listed in Table 5. All amounts are in wt. %, based in the total weight of the emulsion composition, unless otherwise specified.

TABLE 5

| | | | | | Flavorant |
|---|---|---|---|---|---|
| Emulsion | | Potassium | Sunlipon ® | Water, | Formulation |
| System | Potassium Alpha Acid Salt Source | Acid Salt | 65 | Distilled | (%) |
| EMP-01J | Potassium Alpha salt (aq, 20%) | 0.2 | 2.5 | 92.3 | 5 |
| EMP-01K | Potassium Alpha salt (aq, 20%) | 0.05 | 2.5 | 92.45 | 5 |
| EMP-01L | Potassium Iso-Alpha salt (aq, 30%) | 0.01 | 2.5 | 92.49 | 5 |
| EMP-01M | Potassium Tetra-Alpha salt (aq, 30%) | 0.01 | 2.5 | 92.49 | 5 |

### Example 3: Stability Analysis of Oil-in-Water Emulsions with Varying Potassium Alpha Acid Salts

After preparing emulsion compositions incorporating hops, using the methods described in Examples 1 and 2, various physical properties such as density, pH, turbidity, particle size, stability, and consistency of the resulting emulsions were analyzed. First, keeping the flavorant formulation O constant, various emulsion compositions containing inventive emulsion systems (EMP-01J-EMP-01M) were studied to understand the effect of different emulsion systems on the of turbidity (NTU) and particle size distribution data (d50 and 90 (μm)). The results are summarized in the Table 6 below.

TABLE 6

| Emulsion | Flavorant | Turbidity | | |
|---|---|---|---|---|
| System | Formulation | (NTU) | d50 (μm) | d90 (μm) |
| EMP-01J | O | 32 | 0.129 | 0.195 |
| EMP-01L | O | 32.5 | 0.143 | 0.219 |
| EMP-01M | O | 48 | 0.134 | 0.212 |
| EMP-01K | O | 41.5 | 0.157 | 0.259 |

These results show that the emulsion compositions prepared using water-soluble hops acid salts have low particle size distributions as well as low turbidity. This indicates that emulsion compositions prepared using various acid salts can effectively retain small particle sizes, eliminating the need for synthetic adjuvants such as potassium sorbate or potassium benzoate.

### Example 4. Stability Analysis of Oil-in-Water Emulsions with Varying Flavorant Formulations

To understand how different flavorant formulations behave across similar emulsion systems, emulsion compositions containing flavorants A-E were prepared using the same emulsion system A, B or C, and their properties were studied as a function of same emulsion system, but different flavorants. The results are summarized in the Tables 7-9 below.

TABLE 7

| Flavorant | Emulsion | Turbidity | | |
|---|---|---|---|---|
| Formulation | System | (NTU) | d50 (μm) | d90 (μm) |
| A | EMP-01C | 10.3 | 0.179 | 0.2597 |
| B | EMP-01C | 5.47 | 0.204 | 0.3013 |
| C | EMP-01C | 20.5 | 0.152 | 0.228 |
| D | EMP-01C | 12.7 | 0.145 | 0.217 |
| E | EMP-01C | 9.09 | 0.159 | 0.24 |

TABLE 8

| Flavorant | Emulsion | Turbidity | | |
|---|---|---|---|---|
| Formulation | System | (NTU) | d50 (μm) | d90 (μm) |
| A | EMP-01E | 4.05 | 0.139 | 0.206 |
| B | EMP-01E | 1.91 | 0.133 | 0.196 |
| C | EMP-01E | 24.2 | 0.1262 | 0.1908 |
| D | EMP-01E | 6.99 | 0.137 | 0.2088 |
| E | EMP-01E | 4.71 | 0.149 | 0.222 |

TABLE 9

| Flavorant | Emulsion | Turbidity | | |
|---|---|---|---|---|
| Formulation | System | (NTU) | d50 (μm) | d90 (μm) |
| A | EMP-01F | 18 | 0.152 | 0.223 |
| B | EMP-01F | 9.47 | 0.145 | 0.2183 |
| C | EMP-01F | 27.1 | 0.1487 | 0.222 |
| D | EMP-01F | 12.9 | 0.138 | 0.206 |
| E | EMP-01F | 11.7 | 0.148 | 0.22 |

These results show that the inventive emulsion compositions prepared using water-soluble hops acid salts are minimally affected by the flavor compositions, showing similarly low turbidities and particle size distribution within each emulsion composition.

### Example 5: Shelf Life Analysis of Emulsion Compositions

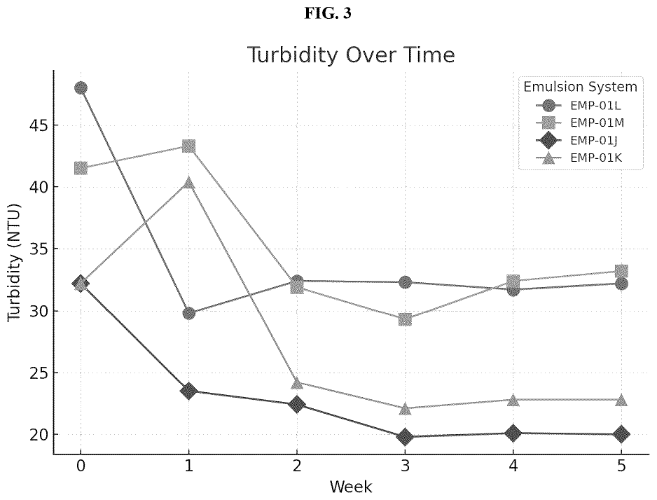

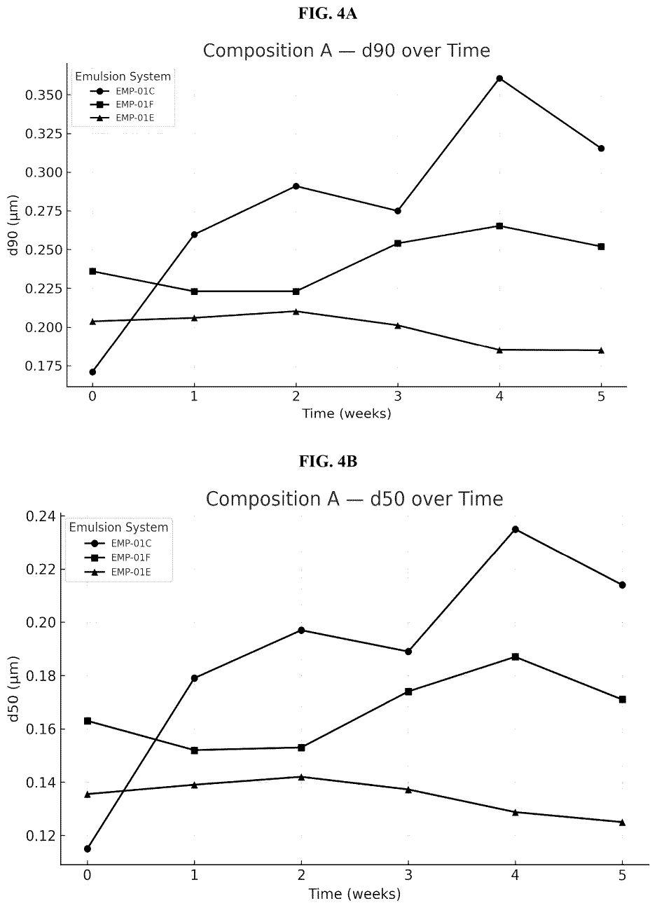

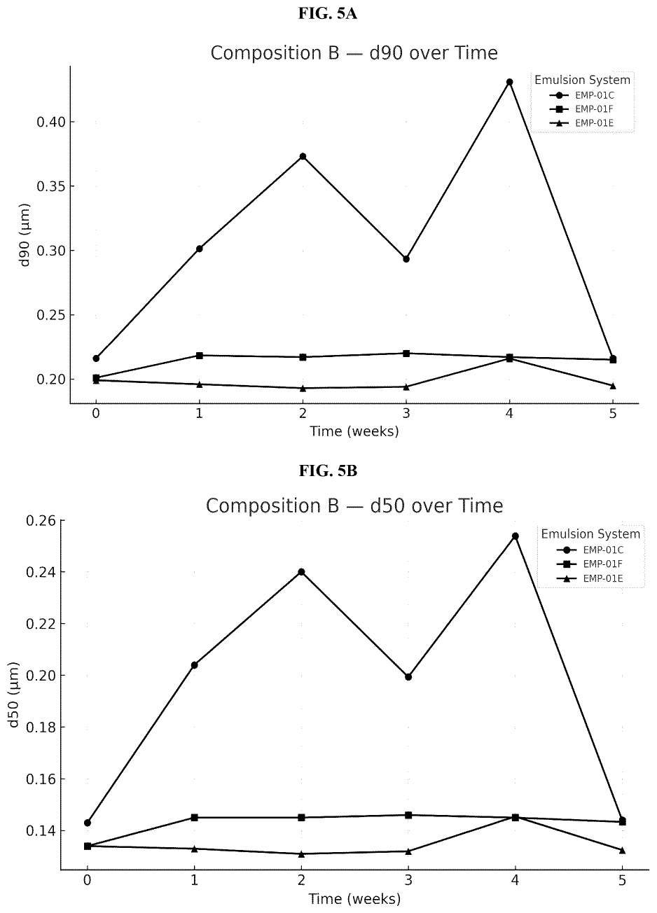

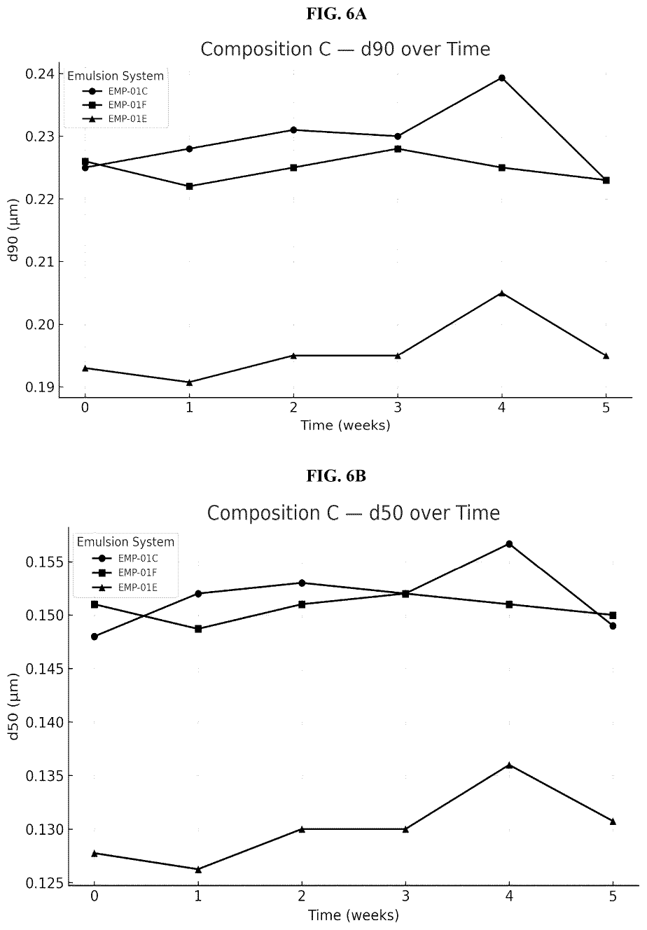

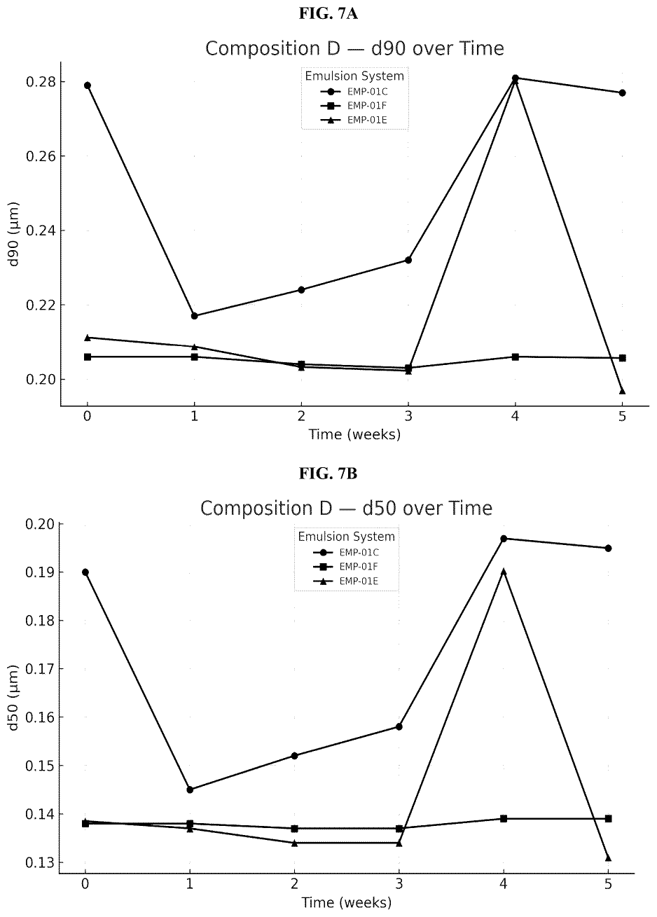

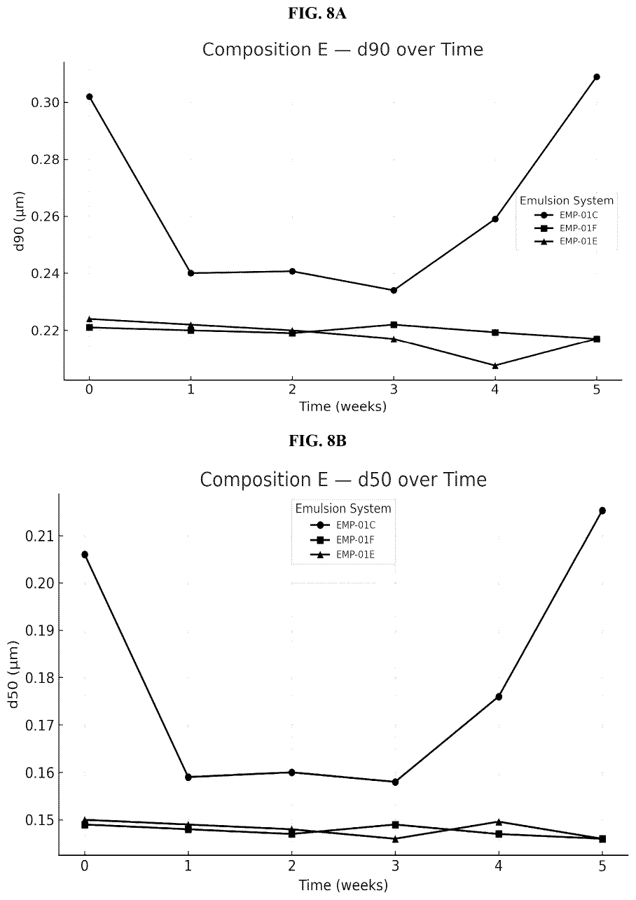

After observing lower turbidities and smaller particle size distributions for the inventive emulsions, accelerated shelf-life (ASL) study was conducted for emulsion storage at 0-5 weeks at 45° C. to determine how emulsion compositions that utilized similar flavorant (composition O) changed as a function of emulsion system over time. FIG. 3 shows the turbidity of these emulsion compositions. The graphs show how the turbidity characteristics of the inventive examples (EMP-01L, EMP-01M, EMP-01J, and EMP-01K) remain exceptionally low (below 50 NTU) over the course of our accelerated shelf-life studies, indicating the various acids provide utility across the emulsion systems. Additionally, similar accelerated shelf life testing was conducted to determine stability of the emulsion systems across the traditional flavor profiles. FIGS. 4-8 shows accelerated shelf-life (ASL) study test data for emulsion storage at 0-5 weeks at 45° C. The ASL test data for inventive oil-in-water emulsions show superior performance in the PSA and turbidity measurements, maintaining smaller d10, d50, and d90 particle size distributions and lower turbidity. Taken together, the results demonstrates that acids derived from hops, when used in their salt forms in the aqueous phase, create stable, low-turbidity emulsions using both traditional flavors and hops related flavors, indicating that they can replace synthetic stabilizing adjuvants such as potassium sorbate or potassium benzoate.

These results show that the emulsions made using natural alpha acids and/or salts thereof are stable, providing a simple but effective alternative to other synthetic commonly used adjuvants.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation, or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from their spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. An oil-in-water emulsion composition comprising:
a first phase comprising:
about 0.01 wt. % to about 30 wt. %, based on a total weight of the emulsion composition, of a flavorant; and
about 0.01 wt. % to about 10 wt. %, based on the total weight of the emulsion composition, of an emulsifier adjuvant; and
a continuous aqueous phase comprising:
water;
about 0.001 wt. % to about 10 wt. %, based on the total weight of the emulsion composition, of a preservative comprising a hop acid, a hop acid salt, or a combination thereof; and
about 0.01 wt. % to about 10 wt. %, based on the total weight of the composition of the emulsion composition, of an emulsifying agent.

2. The oil-in-water emulsion composition of claim 1, wherein the continuous aqueous phase further comprises about 0.01 wt. % to about 8 wt. %, based on the total weight of the emulsion composition, of the preservative.

3. The oil-in-water emulsion composition of claim 1, wherein the hop acid or hop acid salt comprises an alpha acid, a beta acid, a tetra acid, an iso-alpha acid, and salts thereof.

4. The oil-in-water emulsion composition of claim 1, wherein the preservative comprises a hop acid, and the hop acid comprises humulone, cohumulone, adhumulone, lupulone, colupulone, adlupulone, tetrahydroisohumulone, tetrahydroisocohumulone, tetrahydroadlupulone, isohumulone, isocohumulone, isoadhumulone, or a salt thereof.

5. The oil-in-water emulsion composition of claim 1, wherein the preservative comprises a hop acid salt, and the hop acid salt comprises potassium humulone, potassium cohumulone, potassium cohumulone, potassium humulone, potassium cohumulone, potassium adhumulone, potassium lupulone, potassium colupulone, potassium adlupulone, potassium tetrahydroisohumulone, potassium tetrahydroisocohumulone, potassium tetrahydroadlupulone, potassium isohumulone, potassium isocohumulone, or potassium isoadhumulone.

6. The oil-in-water emulsion composition of claim 1, wherein the flavorant comprises hop oil, cannabis oil, hemp oil, hop extract, flavorant blends, hop-derived flavorant compounds, carrier oils, a terpene, a terpene blend, a thiol, a ketone, an ester, an aldehyde, an alcohol, a heterocycle, a phenol, sugars, sugar alcohols, or a combination of any two or more thereof.

7. The oil-in-water emulsion composition of claim 1, wherein the emulsifying agent comprises a phospholipid, gum arabic, ester gum, acacia gum, xanthan gum, guar gum, carrageenan, locust bean gum, monoglycerides, diglycerides, ethoxylated castor oil, albumin, alginates, casein, egg yolk, glycerol monostearate, or a combination of any two or more thereof.

8. The oil-in-water emulsion composition of claim 1, wherein the emulsifying agent comprises a sunflower lecithin.

9. The oil-in-water emulsion composition of claim 1, wherein the emulsifying agent comprises about 0.01% to about 5% by weight of the total weight of the emulsion composition.

10. The oil-in-water emulsion composition of claim 1, wherein the emulsifier adjuvant comprises citric acid, malic acid, tartaric acid, ascorbic acid, caffeic acid, ferulic acid, or a salt thereof.

11. The oil-in-water emulsion composition of claim 1, wherein the water is present in an amount corresponding to the remaining balance of material in the oil-in-water emulsion composition.

12. The oil-in-water emulsion composition of claim 1, wherein the oil-in-water emulsion composition is substantially free of a weighting agent.

13. A product comprising the oil-in-water emulsion composition of claim 1, wherein the product is an edible product, a flavor product, or an aroma product.

14. The product of claim 13, wherein product is the edible product and the edible product comprises a food or beverage.

15. The product of claim 14, wherein the edible product comprises the beverage that is a fermented beverage, optionally wherein the fermented beverage comprises kombucha, beer, wine, or cider.

16. An oil-in-water emulsion composition comprising:
about 0.01 wt. % to about 8 wt. %, based on the total weight of the emulsion composition, of a hop acid and/or a salt thereof;
about 0.5 wt. % to about 10 wt. %, based on a total weight of the emulsion composition, of a flavorant;
about 0.01 wt. % to about 5 wt. %, based on the total weight of the emulsion composition, of a sunflower lecithin; and
water in an amount corresponding to a remaining balance of material in the oil-in-water emulsion composition.

17. The oil-in-water emulsion composition of claim 16, wherein the wherein the hop acid is an alpha acid, and wherein the salt is a potassium salt.

18. A method comprising:
providing an oil phase comprising a flavorant and optionally an emulsifier adjuvant;
providing an aqueous phase comprising water, a preservative comprising a hop acid and/or a salt thereof, an emulsifying agent, and optionally an emulsifier adjuvant;
mixing the oil phase and the aqueous phase to obtain a pre-emulsion; and
homogenizing the pre-emulsion to obtain an oil-in-water emulsion;
wherein the oil-in-water emulsion is substantially free of weighting agents and gum acacia;
optionally wherein the homogenizing comprises a multi-stage homogenization process.

19. A method for stabilizing an oil-in-water emulsion, the method comprising adding to the oil-in-water emulsion a preservative comprising a hop acid, a hop acid salt, or a combination thereof.

20. The method of claim 19, wherein (a) the hop acid comprises one or more of an alpha acid, a beta acid, a tetra acid, and an iso-alpha acid; and (b) the hop acid salt comprises potassium humulone, potassium cohumulone, potassium cohumulone, potassium humulone, potassium cohumulone, potassium adhumulone, potassium lupulone, potassium colupulone, potassium adlupulone, potassium tetrahydroisohumulone, potassium tetrahydroisocohumulone, potassium tetrahydroadlupulone, potassium isohumulone, potassium isocohumulone, or potassium isoadhumulone.
